(19) United States
(12) Patent Application Publication
(10) Pub. No.: US 2024/0003307 A1
(43) Pub. Date: Jan. 4, 2024

(54) CYLINDER CUT-OUT MODES FOR ENGINES

(71) Applicant: Perkins Engines Company Limited, Peterborough (UA)

(72) Inventors: Nicholas TIMMINS, Perton (UA); James PARDOE, Telford (UA); Simaranjit GILL, Edgbaston (UA); Adam TURNOCK, Eccleshll (UA)

(73) Assignee: Perkins Engines Company Limited, Peterborough (UA)

(21) Appl. No.: 18/037,826

(22) PCT Filed: Nov. 24, 2021
(86) PCT No.: PCT/EP2021/025460

§ 371 Date: May 19, 2023

(30) Foreign Application Priority Data
Dec. 1, 2020 (GB) 2018913.0

(51) Int. Cl. F02D 41/00; F02D 41/22

(52) U.S. Cl. CPC F02D 41/0087; F02D 41/22; F02D 2200/101

(57) ABSTRACT

A method of controlling a cylinder cut-out mode for an engine comprising the steps of: a) activating a cylinder cut-out mode in an idling mode or when running with an engine load factor of less than a deactivation threshold value, the cylinder cut-out mode comprising a plurality of sub-modes for different load factor ranges of the engine; b) while the cylinder cut-out mode is active, monitoring one or more deactivation variables; the one or more deactivation variables comprising: i) the engine load factor; and ii) an engine coolant temperature; and c) deactivating the cylinder cut-out mode if at least one of the engine load factor or the engine coolant temperature exceeds, respectively, the deactivation threshold value or an engine coolant temperature threshold value.

The present disclosure relates to a method of controlling a cylinder cut-out mode for an engine. Further, to an engine comprising a plurality of cylinders and a controller which is enabled to activate a cylinder cut-out mode. Further, to a controller for controlling a cylinder cut-out mode of an engine.

### BACKGROUND TO THE DISCLOSURE

On diesel engines having a low compression ratio, cool misfire can be problem when running light loads, resulting in incomplete combustion and the creation of white smoke.

This problem can be exacerbated when running in cold conditions and soon after start-up when the engine is running below its peak operating temperature. These problems may be a particular issue for diesel genset engines used as backup generators since these installations are often situated outside, in cold climates and are used only sporadically.

### SUMMARY OF THE DISCLOSURE

An embodiment of the present disclosure provides a method of controlling a cylinder cut-out mode of an engine, wherein the engine is a diesel engine comprising a plurality of cylinders and has a compression ratio of less than 14:1, the method comprising the steps of:
a) activating a cylinder cut-out mode when the engine is in an idling mode or running with an engine load factor of less than a deactivation threshold value, the cylinder cut-out mode comprising a plurality of sub-modes that are each activated for different load factor ranges of the engine, and in each sub-mode one or more cylinder cut-out patterns are engaged;
b) while the cylinder cut-out mode is active, monitoring one or more deactivation variables; the one or more deactivation variables comprising:
   i) the engine load factor; and
   i) an engine coolant temperature;
   and
c) deactivating the cylinder cut-out mode if at least one of the engine load factor or the engine coolant temperature exceeds, respectively, the deactivation threshold value or an engine coolant temperature threshold value.

Another embodiment of the present disclosure provides an engine comprising a plurality of cylinders and a controller, the controller being enabled to activate a cylinder cut-out mode in which one or more of the plurality of cylinders are deactivated;
the controller being configured to:
a) activate a cylinder cut-out mode when the engine is in an idling mode or running with an engine load factor of less than a deactivation threshold value, the cylinder cut-out mode comprising a plurality of sub-modes that are each activated for different load factor ranges of the engine, and in each sub-mode one or more cylinder cut-out patterns are engaged;
b) while the cylinder cut-out mode is active, monitor one or more deactivation variables; the one or more deactivation variables comprising:
   i) the engine load factor; and
   i) an engine coolant temperature;
   and
c) deactivate the cylinder cut-out mode if at least one of the engine load factor or the engine coolant temperature exceeds, respectively, the deactivation threshold value or an engine coolant temperature threshold value.

Another embodiment of the present disclosure provides a controller for controlling a cylinder cut-out mode of an engine, the controller being configured to:
a) activate a cylinder cut-out mode when the engine is in an idling mode or running with an engine load factor of less than a deactivation threshold value, the cylinder cut-out mode comprising a plurality of sub-modes that are each activated for different load factor ranges of the engine, and in each sub-mode one or more cylinder cut-out patterns are engaged;
b) while the cylinder cut-out mode is active, monitor one or more deactivation variables; the one or more deactivation variables comprising:
   i) the engine load factor; and
   i) an engine coolant temperature;
   and
c) deactivate the cylinder cut-out mode if at least one of the engine load factor or the engine coolant temperature exceeds, respectively, the deactivation threshold value or an engine coolant temperature threshold value.

### BRIEF DESCRIPTION OF THE DRAWINGS

One or more embodiments of the disclosure will now be described, byway of example only, with reference to the accompanying drawings in which:

FIG. 1 is a schematic view of an engine and a controller for illustrating operation of the method;

FIG. 2 is a schematic layout of the cylinders of an 8-cylinder engine; and

FIG. 3 is a schematic layout of the cylinders of a 16-cylinder engine.

### DETAILED DESCRIPTION

Unless defined otherwise, all technical and scientific terms used in this specification have the same meaning as is commonly understood by the reader skilled in the art to which the claimed subject matter belongs. It is to be understood that the foregoing summary of the disclosure and the following examples are exemplary and explanatory only and are not restrictive of any subject matter claimed.

The following description is directed to embodiments of the disclosure. The description of the embodiments is not meant to include all the possible embodiments of the disclosure that are claimed in the appended claims. Many modifications, improvements and equivalents which are not explicitly recited in the following embodiments may fall within the scope of the appended claims. Features described as part of one embodiment may be combined with features of one or more other embodiments unless the context clearly requires otherwise.

In this specification, the use of the singular includes the plural unless the context clearly dictates otherwise. In this application, the use of “and/or” means “and” and “or” unless stated otherwise.

The method may be applied to an engine to control the functioning of the engine. The method may be applied during idle of an engine and/or during low load conditions of an engine.

The engine may form part of a machine or may be a stand-alone engine.

The engine may form part of generator, also referred to as a genset. The generator may be a stationary generator or mobile generator. The generator may be a standby generator.

The generator may be used to generate electricity or electricity and useful heat in combination as part of a combined heat and power (CHP) generator. The engine may be a fixed-speed engine.

The engine may be or comprise an internal combustion engine (ICE). The ICE may use diesel as its primary fuel. The diesel may, for example, be conventional diesel or biodiesel.

The engine may have multiple cylinders. The engine may have 2 or more cylinders, optionally 4 or more cylinders, optionally 6 or more cylinders, optionally 8 or more cylinders, optionally 12 or more cylinders, optionally 16 or more cylinders, optionally 24 or more cylinders.

The engine may have a power density of greater than 20 bar gross BMEP, optionally greater than 28 bar gross BMEP, optionally greater than 30 bar gross BMEP.

The engine may have a cylinder displacement of 3 litres or more per cylinder. The engine may have an engine displacement of 23 litres or more, optionally 23 to 61 litres.

The engine may have a compression ratio of less than 14:1.

The method may be applied to the engine when the engine is operating in conditions where an ambient temperature surrounding the engine is less than 10° C.

The method may be performed in whole or in part by operation of a controller. The controller may comprise hardware and/or software. The controller may comprise a control unit or may be a computer program running on a dedicated or shared computing resource.

The controller may comprise a single unit or may be composed of a plurality of sub-units that are operatively connected. The controller may be located on one processing resource or may be distributed across spatially separate computing resources. The controller may comprise one or more programmable and or non-programmable memory units or sub-units.

The controller may comprise data storage and handling units or sub-units. The controller may comprise or form part of an engine electronic control module (ECM) operatively connected to the engine.

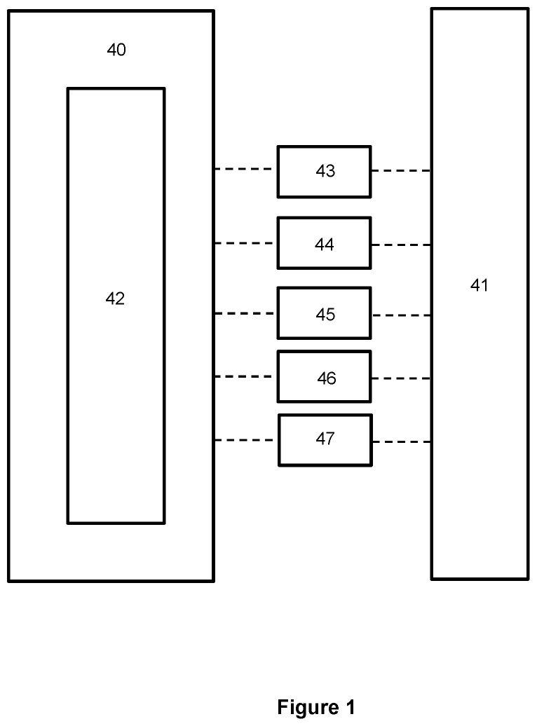

FIG. 1 shows a schematic view of an engine 40 and a controller 41 for illustrating operation of the method. The engine 40 may comprises a plurality of cylinders 42.

The controller 41 may utilise as part of the method one or more variables associated with operation of the engine 40. The variables may comprise one or more of an engine speed 43, an engine coolant temperature 44, an engine intake manifold temperature 45, an engine load factor 46 and an ambient temperature 47.

The engine 40 and/or controller 41 may comprise one or more associated sensors for detecting, determining, calculating or inferring the aforementioned variables. For example, one or more of an engine coolant temperature sensor, an engine intake manifold temperature sensor, an engine speed sensor, an engine manifold absolute pressure sensor, a throttle position sensor, an air intake sensor and an ambient temperature sensor may be provided.

The engine 40 may be started by issuing an engine start command. The engine start command may comprise actuation of a virtual or physical key, switch, button or other actuator. In some embodiments the engine start command is provided by a key that is used to operate an ignition controller. Starting of the engine 40 may be under the control of the controller 41.

During operation the controller 41 may check whether certain enablement conditions are met before activating a cylinder cut-out mode of the present disclosure. The enablement conditions may comprise one or more of whether the cylinder cut-out mode is enabled in the controller 41, whether any fault conditions are detected in the fuel injectors associated with the cylinders 42 of the engine 40, whether any fault conditions are detected associated with the engine speed 43 or engine speed sensor, and whether the engine speed 43 is not zero. Optionally, the cylinder cut-out mode may be enabled only once the enablement conditions have been deemed satisfactory.

Once the enablement conditions are deemed satisfactory, the controller 41 may check whether entry conditions for the cylinder cut-out mode are met. The entry conditions may comprise one or more of:
the engine coolant temperature 44 is below or equal to an engine coolant temperature threshold value;
the engine intake manifold temperature 45 is below or equal to an engine intake manifold temperature threshold value; and
the engine load factor 46 is below a deactivation threshold value.

Optionally, the entry conditions may be deemed as met only when all of the above statements are TRUE. Preferably, the cylinder cut-out mode is entered only once all of the entry conditions have been deemed as MET.

The entry conditions may comprise one or more engine coolant temperature threshold values. The entry conditions may comprise one or more engine intake manifold temperature threshold values. The entry conditions may comprise one or more deactivation threshold values.

The entry conditions may optionally comprise one or more sets of threshold values, each set specifying an engine coolant temperature threshold value, and engine intake manifold temperature threshold value and a deactivation threshold value. For example, the entry conditions may comprise at least a first set of entry conditions and a second set of entry conditions.

The entry conditions or the set of entry conditions operative at a specific time may be determined by the controller 41 using the ambient temperature 47 as sensed by, for example, the ambient temperature sensor. For example, the first set of entry conditions may be operative for a first range of ambient temperature and the second set of entry conditions may be operative for a second range of ambient temperature. For example, the first set of entry conditions may be operative when the ambient temperature is below an ambient temperature threshold value and the second set of entry conditions may be operative when the ambient temperature is above the ambient temperature threshold value. The ambient temperature threshold value may be set at any value between −40° C. and 60° C., optionally between −10° C. and 15° C.

The one or more engine coolant temperature threshold values may be set at a temperature of −60 to 150° C., optionally −40 to 90° C.

The one or more engine intake manifold temperature threshold values may be set at a temperature of −60 to 300° C., optionally −40 to 60° C.

The one or more deactivation threshold values for the engine load factor 46 may be set at a suitable percentage to restrict the cylinder cut-out mode to operate during idle and low load conditions of the engine 40. For example, the one or more deactivation threshold values may be selected as a value in the range of 30 to 50%, optionally 35 to 45%, optionally 40 to 45%, optionally 40%, optionally 45%.

Optionally, one or more of the variables of the engine speed 43, the engine coolant temperature 44, the engine intake manifold temperature 45, the engine load factor 46 and the ambient temperature 47 may be associated with a debounce variable that may function to prevent the controller 41 calling on the respective variable too frequently or acting too hastily to the respective variable exceeding its threshold value. For example, the variable of the engine coolant temperature 44 may have a debounce variable set at a time of 0 to 60 seconds. For example, the engine intake manifold temperature 45 may have a debounce variable set at a time of 0 to 60 seconds. For example, the engine load factor 46 may have a debounce variable set at a time of 0 to 10 seconds. For example, the ambient temperature 47 may have a debounce variable set at a time of 0 to 60 seconds.

The controller 41 may determine whether the engine speed 43 is below or equal to an engine speed threshold. The engine speed threshold may be a speed of 0 to 2000 rpm. The engine speed threshold may be used to determine if there is no engine speed or an inadequate engine speed to require or warrant the cylinder cut-out mode to be activated.

The controller 41 may determine whether the engine 40 is cranking or running by monitoring the engine speed. The determinant may be, for example, a specified rpm engine speed or a predetermined offset from a desired rpm engine speed. For example, if a desired running speed (which may, optionally, be a fixed desired running speed) for the engine 40 is 3000 rpm the controller 41 may be configured to treat engine speeds below, for example, 2900 rpm as the engine 40 undergoing cranking and speeds above 2900 rpm as the engine 40 running. In another example, the controller 41 may be configured to treat engine speeds within, for example, 100 rpm of a desired running speed as the engine 40 running and all lower speeds as cranking. The controller 41 may be configured such that once the engine 40 is determined to be running, the engine 40 cannot be determined to be cranking until the engine 40 is shut-off and restarted.

The controller 41 may activate the cylinder cut-out mode when the engine 40 is in an idling mode or running with an engine load factor 46 of less than the deactivation threshold value. As noted above, the deactivation threshold value may, for example be selected as a value in the range of 30 to 50%, for example 40% or 45% may be typical values selected.

The cylinder cut-out mode may comprise a plurality of sub-modes that are each activated for different load factor ranges of the engine 40. The cylinder cut-out mode may comprise 2, 3, 4, 5, or more sub-modes.

A first sub-mode may be activated in a load factor range of 0%-15% or 0%-20% or 0%-25% or 0%-30% or 0%-35%. A second sub-mode may be activated in a load factor range of 15%-30% or 15%-35% or 20%-30% or 20%-35% or 30%-35% or 30%-40% or 35%-40%. A third sub-mode may be activated in a load factor range of 30%-40% or 30%-45% or 35%-40% or 35%-45%. Fourth, fifth and additional sub-modes may be provided if required.

In the first sub-mode a predetermined number of cylinders 42 may be cut-out, i.e. deactivated. In the second sub-mode a predetermined number of cylinders 42 may be cut-out that may be the same or less than the number of cylinders 42 cut-out in the first sub-mode. In the third sub-mode a predetermined number of cylinders 42 may be cut-out that may be the same or less than the number of cylinders 42 cut-out in the second sub-mode. etc.

For example, for an inline 8 cylinder engine the following sub-modes may be applied:

| Sub-mode | Load Factor range | No. of cylinders cut-out |
|---|---|---|
| 1 | 0%-20% | Up to 4 |
| 2 | 20%-30% | 2 |
| 3 | 30%-35% | 2 |
| 4 | 35%-40% | 1 |
| 5 | 40%-45% | 0 |

For example, for a vee 16 cylinder engine the following sub-modes may be applied:

| Sub-mode | Load Factor range | No. of cylinders cut-out |
|---|---|---|
| 1 | 0%-20% | Up to 8 |
| 2 | 20%-30% | Up to 8 |
| 3 | 30%-35% | Up to 8 |
| 4 | 35%-40% | Up to 4 |
| 5 | 40%-45% | 0 |

In the examples above the fifth sub-mode may have no cylinders 42 cut-out. Thus the controller 41 may be configured to maintain activation of the cylinder cut-out mode in the load factor range of 40%-45% in readiness for the possibility that the engine load factor 46 will decrease below 40%. If the engine load factor 46 increases above 45% then the cylinder cut out mode may be deactivated, i.e. the deactivation threshold value is set to 45%. In an alternative example the controller 41 may be configured to deactivate the cylinder cut-out mode at a load factor 40% (i.e. to not use the fifth sub-mode), i.e. the deactivation threshold value is set to 40%.

In the first sub-mode it may be preferred that up to one-half of the cylinders 42 may be deactivated, i.e. up to 4 cylinders in an 8-cylinder engine, up to 8 cylinders in a 16-cylinder engine, etc.

In the second (or higher) sub-mode up to one-quarter of the cylinders 42 may be deactivated, i.e. up to 2 cylinders in an 8-cylinder engine, up to 4 cylinders in a 16-cylinder engine, etc.

In the third (or higher) sub-mode up to one-eighth of the cylinders 42 may be deactivated, i.e. 1 cylinder in an 8-cylinder engine, up to 2 cylinders in a 16-cylinder engine, etc.

The controller 41 may move the cylinder cut-out mode up and down through the sub-modes as required in response to changing load factors experienced by the engine 40.

In each sub-mode one or more cylinder cut-out patterns may be engaged. For example, in in one or more of the sub-modes 2, 3, 4, or more cylinder cut-out patterns may be engaged.

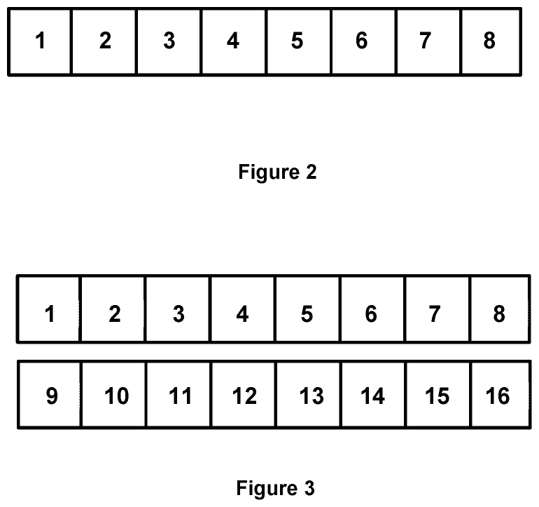

For example, a cylinder lay-out for an inline 8-cylinder engine is shown schematically in FIG. 2. The cylinders 42 are numbered 1 to 8. The following cut-out patterns may be utilised, for example, as required in the one or more sub-modes:

| Total number of cylinders cut-out | Cylinder numbers that are cut-out |
|---|---|
| Up to 4 | Any of 1, 2, 3, 4 |
| Up to 4 | Any of 5, 6, 7, 8 |
| 2 | 1, 8 |
| 1 | 1 or 8 |

Where the total number of cylinders cut-out is 2 it may be preferred to cut-out the end-most cylinders 1 and 8 in the example of an inline engine. Where the total number of cylinders cut-out is 1 it may be preferred to cut-out one of the end-most cylinders, e.g. 1 or 8 in the example of an inline engine.

For example, a cylinder lay-out for a vee 16-cylinder engine is shown schematically in FIG. 3. The cylinders 42 are numbered 1 to 16. Cylinders 1 to 8 form a first bank of cylinders and cylinders 9 to 16 form a second bank of cylinders. It will be appreciated that the numbering used in FIG. 3 for the cylinder numbers is only an example and other numbering conventions may be used—e.g. odd cylinders on one side/bank and even cylinders on the other side/bank. The following cut-out patterns may be utilised, for example, as required in the one or more sub-modes:

| Total number of | |
|---|---|
| cylinders cut-out | Cylinder numbers that are cut-out |
| Up to 8 | 1 to 8 |
| Up to 8 | 9 to 16 |
| Up to 8 | 1, 3, 5, 7, 10, 12, 14, 16 |
| Up to 8 | 2, 4, 6, 8, 9, 11, 13, 15, 17 |
| Up to 4 | Any two of 1 to 8 + Any two of 9 to 16 while |
| | maintaining a crank angle between 135- |
| | 180 degrees between cut-out cylinders |

The cylinder cut-out patterns, for example within a sub-mode, may be engaged sequentially in one or more predetermined switching patterns. Optionally a timing of the switching may be controlled by a pattern switch timer of the controller 41. For example, in the case of the vee 16-cylinder engine in the example above, the first sub-mode may cut out 8 cylinders. The 8 cylinders being cut-out may switch intermittently between cylinders 1 to 8 and cylinders 9 to 16. Switching may occur at regular intervals, for example, every 5, 10, 15, or 20 seconds.

Additionally or alternatively to switching patterns during a single activation of the cylinder cut-out mode based on the pattern switch timer of the controller 41, the controller 41 may be configured to switch the pattern(s) of deactivated cylinders in one or more of the sub-modes between sequential activations of the cylinder cut-out mode. For example, the controller 41 may be configured to switch patterns in one or more of the sub-modes each time the cylinder cut-out mode is activated. The controller 41 may alternate between two, three, four or more patterns. Each switchable pattern within a sub-mode may have the same number of deactivated cylinders as each of the other switchable patterns of that sub-mode, i.e. while the identity of the cylinders cut-out in a sub-mode may be changed, the total number of cylinders cut-out in that specific sub-mode may be kept constant. Each of the switchable patterns may be predetermined and stored in a lookup table (or equivalent) accessible to the controller 41.

For example, for an inline 8-cylinder engine an example could be:

| | | Total | Pattern 1 of | Pattern 2 of |
|---|---|---|---|---|
| | Engine | number of | Cylinder | Cylinder |
| | Load | cylinders | numbers that | numbers that |
| Sub-mode | Factor | cut-out | are cut-out | are cut-out |
| First | 0%-20% | 4 | 5, 6, 7, 8 | 1, 2, 3, 4 |
| Second | 20%-30% | 2 | 1, 8 | 1, 8 |
| Third | 30%-35% | 1 | 1 | 8 |

Pattern 1 may be used, for example, on a first activation of the cylinder cut-out mode, Pattern 2 may be used on a second activation of the cylinder cut-out mode, Pattern 1 may be used on a third activation of the cylinder cut-out mode, and so on. Both Pattern 1 and Pattern 2 have the same number of cylinders cut-out (4 in the First mode, 2 in the Second mode and 1 in the Third mode, and it is only the identity of the cut-out cylinders that is switched.)

In general, each sub-mode (which may or may not be configured to comprise two or more switchable patterns) may be activated at a predetermined load factor that is stored in a lookup table (or equivalent) accessible to the controller 41. Additionally or alternatively, the identity and patterns of the cylinders to be deactivated in each sub-mode may be predetermined and stored in the lookup table accessible to the controller 41.

For example, for an inline 8-cylinder engine an example lookup table may contain the following settings:

| | Engine Load | Total number of | Cylinder numbers |
|---|---|---|---|
| Sub-mode | Factor | cylinders cut-out | that are cut-out |
| First | 0%-20% | 4 | 5, 6, 7, 8 |
| Second | 20%-30% | 2 | 1, 8 |
| Third | 30%-35% | 1 | 1 |

Thus, in this example the predetermined cylinders 5, 6, 7, 8 will be deactivated when the engine load factor is 0%-20%. Once the engine load factor increases above 20% cylinders 1, 8 will be deactivated and cylinders 5, 6, 7 will be reactivated. Once the engine load factor increases above 30% cylinder 1 will remain deactivated and cylinder 8 will be reactivated. Decreasing engine load factor will also cause predetermined changes in the activated cylinders, e.g. the engine load factor decreasing from 25% to 15% will, at the trigger point of 20%, cause cylinder 1 to deactivate and cylinders 5, 6, 7 to activate.

The sub-modes may be configured such that a capacity of the engine 40, while the cylinder cut-out mode is active, is increased and decreased directly in step with increasing and decreasing load factor of the engine 40.

While the cylinder cut-out mode is active, the controller 41 monitors one or more deactivation variables to determine whether to continue to run the cylinder cut-out mode, whether to temporarily deactivate (pause) the cylinder cut-out mode, or whether to deactivate (exit) the cylinder cut-out mode.

The one or more deactivation variables may comprise the engine load factor 46 and the engine coolant temperature 44.

The cylinder cut-out mode may be deactivated (paused temporarily or exited completely) if at least one of the engine load factor 46 or the engine coolant temperature 44 exceeds, respectively, the deactivation threshold value or the engine coolant temperature threshold value. For example, the deactivation of the cylinder cut-out mode may be a temporary deactivation of the cylinder cut-out mode until the engine load factor 46 returns below the deactivation threshold value.

Optionally while the cylinder cut-out mode is active, the controller 41 may monitor an engine speed error and deactivate the cylinder cut-out mode if the engine speed error exceeds a speed error threshold value. The engine speed threshold value may be a fixed value of rpm, a percentage value of the desired engine speed rpm, etc. For example, the engine speed threshold amount may be set at a value of 1 to 300 rpm. In one example the threshold amount is set as 30 rpm. This deactivation of the cylinder cut-out mode may be a temporary deactivation of the cylinder cut-out mode until the engine speed error returns below the speed error threshold value.

The controller 41 may deactivate the cylinder cut-out mode until the engine 40 is restarted if the engine coolant temperature 44 exceeds the engine coolant temperature threshold value.

### INDUSTRIAL APPLICABILITY

The present disclosure may find application in controlling a cylinder cut-out mode for an engine.

The engine may be or comprise an internal combustion engine (ICE). The ICE may use diesel as its primary fuel. In some examples the engine may be a diesel genset engine.

The present disclosure may find particular benefit where the engine is operated in cold conditions—for example where an ambient temperature surrounding the engine is less than 10° C. In such conditions, it can be a challenge to start an engine without starting aids, especially for ICEs that use diesel as the primary fuel. For example, in cold conditions there may be multiple cylinders that do not combust until load is applied to the engine or the engine coolant warms up. Cool misfire a poor incomplete combustion may lead to unfavourable conditions such as increased vibration, noise and emission of white smoke-indicative of unburnt hydrocarbons.

According to the present disclosure there is provided a method of controlling a cylinder cut-out mode of an engine that may assist with engine operation, especially in cold conditions. In particular, the method may assist in reducing the occurrence of cool misfire by more efficiently heating and maintaining the heat in firing cylinders of the engine. Cylinder cut-out patterns may be chosen dependent on the capacity and brake kilowatt output of the engine. The patterns and number of activated cylinders may also be tuned against the engine coolant temperature and the load of the engine.

It finds particular application where the engine is a diesel engine comprising a plurality of cylinders and has a compression ratio of less than 14:1 and, optionally, where the engine is running on a diesel fuel having a Cetane number of 45 or less, optionally 40 or less.

The engine may have a power density of greater than 20 bar gross BMEP, optionally greater than 28 bar gross BMEP, optionally greater than 30 bar gross BMEP. The engine may have a cylinder displacement of 3 litres or more per cylinder and/or an engine displacement of 23 litres or more, optionally 23 to 61 litres.

The method of controlling a cylinder cut-out mode for an engine of the present disclosure may comprise the steps of:
a) activating a cylinder cut-out mode when the engine is in an idling mode or running with an engine load factor of less than a deactivation threshold value, the cylinder cut-out mode comprising a plurality of sub-modes that are each activated for different load factor ranges of the engine, and in each sub-mode one or more cylinder cut-out patterns are engaged;
b) while the cylinder cut-out mode is active, monitoring one or more deactivation variables; the one or more deactivation variables comprising:
   i) the engine load factor; and
   ii) an engine coolant temperature;
   and
c) deactivating the cylinder cut-out mode if at least one of the engine load factor or the engine coolant temperature exceeds, respectively, the deactivation threshold value or an engine coolant temperature threshold value.

Beneficially the method of the present disclosure may improve the starting and running of an internal combustion engine (ICE) using diesel in cold conditions. In particular it may reduce the amount of visible white smoke generated when the engine is operating under low load conditions and below its peak operating conditions.

Each sub-mode may be activated at a predetermined load factor that is stored in a lookup table (or equivalent) accessible to a controller of the engine.

The identity and patterns of the cylinders to be deactivated in each sub-mode may be predetermined and stored in the lookup table (or equivalent) accessible to the controller of the engine.

The sub-modes may be configured such that a capacity of the engine, while the cylinder cut-out mode is active, is increased and decreased directly in step with increasing and decreasing load factor of the engine.

Beneficially, storing the activation load factor for each sub-mode in the lookup table (or equivalent) permits the controller to use predetermined activation points for each sub-mode. Thus, the need for any evaluation or testing of the cylinders during engine running is avoided. This may result in a faster and simpler control scheme for controlling the cylinder cut-out mode. Additionally or alternatively, the method beneficially permits the overall engine capacity to be increased and decreased in step with changes to the load factor experienced by the engine. Again, this may be achieved without the need for any evaluation or testing of the cylinders during engine running.

The cylinder cut-out mode may comprise 2, 3, 4, 5, or more sub-modes.

A first sub-mode may be activated in a load factor range of 0%-15% or 0%-20% or 0%-25% or 0%-30% or 0%-35%. In the first sub-mode up to one-half of the plurality of cylinders may be deactivated, for example.

A second sub-mode may be activated in a load factor range of 15%-30% or 15%-35% or 20%-30% or 20%-35% or 30%-35% or 30%-40% or 35%-40%. In the second sub-mode up to one-quarter of the plurality of cylinders may be deactivated, for example.

A third sub-mode may be activated in a load factor range of 30%-40% or 30%-45% or 35%-40% or 35%-45%. In the third sub-mode up to one-eighth of the plurality of cylinders may be deactivated, for example.

The deactivation threshold value may be selected as a value in the range of 30 to 50%, optionally 35 to 45%, optionally 40 to 45%, optionally 40%, optionally 45%.

In one or more of the sub-modes 2, 3, 4, or more cylinder cut-out patterns may be engaged. In one or more of the sub-modes the 2, 3, 4, or more cylinder cut-out patterns may be engaged sequentially in one or more predetermined switching patterns. Optionally a timing of the switching may be controlled by a pattern switch timer. Optionally in one or more of the sub-modes the 2, 3, 4, or more cylinder cut-out patterns are switched between sequential activations of the cylinder cut-out mode. Optionally the predetermined switching patterns may be stored in a lookup table (or equivalent) accessible to a controller of the engine. 15.

In step c), the deactivation of the cylinder cut-out mode may be a temporary deactivation of the cylinder cut-out mode until the engine load factor returns below the deactivation threshold value.

In step b), the method may further comprise, while the cylinder cut-out mode is active, monitoring an engine speed error. In step c), the method may also further comprise deactivating the cylinder cut-out mode if the engine speed error exceeds a speed error threshold value. Optionally the deactivation of the cylinder cut-out mode may be a temporary deactivation of the cylinder cut-out mode until the engine speed error returns below the speed error threshold value.

In step c), the method may comprise deactivating the cylinder cut-out mode until the engine is restarted if the engine coolant temperature exceeds the engine coolant temperature threshold value.

A controller of the engine may be configured to activate each sub-mode at a predetermined load factor that is stored in a lookup table accessible to the controller.

The identity and patterns of the cylinders to be deactivated in each sub-mode may be predetermined and stored in a lookup table accessible to the controller.

The controller may be configured to increase and decrease the capacity of the engine, using the plurality of sub-modes, directly in step with increasing and decreasing load factor of the engine.

It is to be understood that at least some of the figures and descriptions of the disclosure have been simplified to focus on elements that are relevant for a clear understanding of the disclosure, while eliminating, for purposes of clarity, other elements that the reader skilled in the art will appreciate may also be required. Because such elements are well known to the reader skilled in the art, and because they do not necessarily facilitate a better understanding of the disclosure, a description of such elements is not provided herein.

1. A method of controlling a cylinder cut-out mode of an engine, wherein the engine is a diesel engine comprising a plurality of cylinders and has a compression ratio of less than 14:1, the method comprising the steps of:
a) activating a cylinder cut-out mode when the engine is in an idling mode or running with an engine load factor of less than a deactivation threshold value, the cylinder cut-out mode comprising a plurality of sub-modes that are each activated for different load factor ranges of the engine, and in each sub-mode one or more cylinder cut-out patterns are engaged;
b) while the cylinder cut-out mode is active, monitoring one or more deactivation variables; the one or more deactivation variables comprising:
i) the engine load factor; and
ii) an engine coolant temperature;
and
c) deactivating the cylinder cut-out mode if at least one of the engine load factor or the engine coolant temperature exceeds, respectively, the deactivation threshold value or an engine coolant temperature threshold value.

2. The method of claim 1, wherein each sub-mode is activated at a predetermined load factor that is stored in a lookup table accessible to a controller of the engine.

3. The method of claim 1, wherein the identity and patterns of the cylinders to be deactivated in each sub-mode is predetermined and stored in a lookup table accessible to a controller of the engine.

4. The method of claim 1, wherein the sub-modes are configured such that a capacity of the engine, while the cylinder cut-out mode is active, is increased and decreased directly in step with increasing and decreasing load factor of the engine.

5. The method of claim 1, wherein the cylinder cut-out mode comprises 2, 3, 4, 5, or more sub-modes.

6. The method of claim 1, wherein a first sub-mode is activated in a load factor range of 0%-15% or 0%-20% or 0%-25% or 0%-30% or 0%-35%.

7. The method of claim 6, wherein in the first sub-mode up to one-half of the plurality of cylinders are deactivated.

8. The method of claim 1, wherein a second sub-mode is activated in a load factor range of 15%-30% or 15%-35% or 20%-30% or 20%-35% or 30%-35% or 30%-40% or 35%-40%.

9. The method of claim 8, wherein in the second sub-mode up to one-quarter of the plurality of cylinders are deactivated.

10. The method of claim 1, wherein a third sub-mode is activated in a load factor range of 30%-40% or 30%-45% or 35%-40% or 35%-45%.

11. The method of claim 10, wherein in the third sub-mode up to one-eighth of the plurality of cylinders are deactivated.

12. The method of claim 1, wherein the deactivation threshold value is selected as a value in the range of 30 to 50%, optionally 35 to 45%, optionally 40 to 45%, optionally 40%, optionally 45%.

13. The method of claim 1, wherein in one or more of the sub-modes 2, 3, 4, or more cylinder cut-out patterns are engaged.

14. The method of claim 13, wherein in one or more of the sub-modes the 2, 3, 4, or more cylinder cut-out patterns are engaged sequentially in one or more predetermined switching patterns; and optionally a timing of the switching is controlled by a pattern switch timer; and optionally the predetermined switching patterns are stored in a lookup table accessible to a controller of the engine.

15. The method of claim 13, wherein in one or more of the sub-modes the 2, 3, 4, or more cylinder cut-out patterns are switched between sequential activations of the cylinder cut-out mode.

16. The method of claim 1, wherein, in step c), the deactivation of the cylinder cut-out mode is a temporary deactivation of the cylinder cut-out mode until the engine load factor returns below the deactivation threshold value.

17. The method of claim 1, wherein:
in step b), the method further comprises while the cylinder cut-out mode is active, monitoring an engine speed error; and
in step c), the method further comprises deactivating the cylinder cut-out mode if the engine speed error exceeds a speed error threshold value; and optionally wherein the deactivation of the cylinder cut-out mode is a temporary deactivation of the cylinder cut-out mode until the engine speed error returns below the speed error threshold value.

18. The method of claim 1, wherein, in step c), the method comprises deactivating the cylinder cut-out mode until the engine is restarted if the engine coolant temperature exceeds the engine coolant temperature threshold value.

19. The method of claim 1, wherein the engine is a fixed-speed engine, optionally a fixed-speed diesel genset engine.

20. The method of claim 1, wherein the engine is running on a diesel fuel having a Cetane number of 45 or less, optionally 40 or less.

21. The method of claim 1, wherein the engine has a power density of greater than 20 bar gross BMEP, optionally greater than 28 bar gross BMEP, optionally greater than 30 bar gross BMEP; and/or
the engine has a cylinder displacement of 3 litres or more per cylinder; and/or
the engine has an engine displacement of 23 litres or more, optionally 23 to 61 litres.

22. An engine comprising a plurality of cylinders and a controller, the controller being enabled to activate a cylinder cut-out mode in which one or more of the plurality of cylinders are deactivated;
the controller being configured to:
a) activate a cylinder cut-out mode when the engine is in an idling mode or running with an engine load factor of less than a deactivation threshold value, the cylinder cut-out mode comprising a plurality of sub-modes that are each activated for different load factor ranges of the engine, and in each sub-mode one or more cylinder cut-out patterns are engaged;
b) while the cylinder cut-out mode is active, monitor one or more deactivation variables; the one or more deactivation variables comprising:
i) the engine load factor; and
ii) an engine coolant temperature;
and
c) deactivate the cylinder cut-out mode if at least one of the engine load factor or the engine coolant temperature exceeds, respectively, the deactivation threshold value or an engine coolant temperature threshold value.

23. The engine of claim 22, wherein the controller is configured to activate each sub-mode at a predetermined load factor that is stored in a lookup table accessible to the controller.

24. The engine of claim 22, wherein the identity and patterns of the cylinders to be deactivated in each sub-mode is predetermined and stored in a lookup table accessible to the controller.

25. The engine of claim 22, wherein the controller is configured to increase and decrease the capacity of the engine, using the plurality of sub-modes, directly in step with increasing and decreasing load factor of the engine.
